(19) United States
(12) Patent Application Publication
(10) Pub. No.: US 2014/0198019 A1
(43) Pub. Date: Jul. 17, 2014

(54) DISPLAY APPARATUS AND DISPLAY PANEL THEREOF

(71) Applicant: CHUNGHWA PICTURE TUBES, LTD., Taoyuan (TW)

(72) Inventors: Yi-Ching Wei, Miaoli County (TW); Yuan-Yi Liao, New Taipei City (TW); Sheh-Cha Cho, Tainan City (TW)

(73) Assignee: CHUNGHWA PICTURE TUBES, LTD., Taoyuan (TW)

(21) Appl. No.: 13/787,825

(22) Filed: Mar. 7, 2013

(30) Foreign Application Priority Data
Jan. 17, 2013 (TW) 102201037

(51) Int. Cl. G09G 3/36

(52) U.S. Cl. CPC G09G 3/3685
USPC 345/87

(57) ABSTRACT

A display apparatus and display panel thereof are provided. The display panel includes pixels, first lines, second lines, and data lines. The pixels are located at a display area of the display panel. The first lines are located on a first side of the display area and receive first data signals. The second lines are located on a second side of the display area and receive second data signals. The second side is opposite to the first side. The data lines are electrically connected to the corresponding pixels, respectively. Each of the (4i+1)^{th} and (4i+2)^{th} data lines is electrically connected to one of the (2i+1)^{th} and (2i+2)^{th} first lines exclusively, and each of the (4i+3)^{th} and (4i+4)^{th} data lines is electrically connected to one of the (2i+1)^{th} and (2i+2)^{th} second lines exclusively, wherein i is an integer greater than or equal to 0.

### CROSS-REFERENCE TO RELATED APPLICATION

This application claims the priority benefit of Taiwan application serial no. 102201037, filed on Jan. 17, 2013. The entirety of the above-mentioned patent application is hereby incorporated by reference herein and made a part of this specification.

### BACKGROUND OF THE INVENTION

1. Field of the Invention

The invention generally relates to a display technology, and more particularly to a display apparatus and a display panel thereof

2. Description of Related Art

In a liquid crystal display (LCD) apparatus, pixels are generally arranged in a stripe-like manner, a mosaic-like manner, and a delta-like manner. When a display panel is applied to a portable electronic apparatus, the common voltage of the display panel is normally a direct-current (DC) voltage in order to reduce power consumption of the portable electronic apparatus. Nonetheless, given that the display panel is driven by the DC voltage, color errors are apt to occur between blocks of the display panel, and so are the vertical stripes. Therefore, how to improve the display effects of the display panel driven by the DC common voltage has become one of the focuses of designing the display apparatus.

### SUMMARY OF THE INVENTION

The invention is directed to a display apparatus and a display panel thereof which may achieve improved display effects.

In an embodiment of the invention, a display panel that includes a substrate, a plurality of pixels, a plurality of first lines, a plurality of second lines, and a plurality of data lines is provided. The pixels are disposed on the substrate and located at a display area of the display panel. The first lines are disposed on the substrate and located on a first side of the display area. Besides, the first lines receive a plurality of first data signals. The second lines are disposed on the substrate and located on a second side of the display area, and the second lines receive a plurality of second data signals, wherein the second side of the display area is opposite to the first side of the display area. The data lines are electrically connected to the corresponding pixels, wherein each of the (4i+1)^{th} and (4i+2)^{th} data lines is electrically connected to one of the (2i+1)^{th} and (2i+2)^{th} first lines exclusively, so as to transmit the corresponding first data signals to the corresponding pixels; each of the (4i+3)^{th} and (4i+4)^{th} data lines is electrically connected to one of the (2i+1)^{th} and (2i+2)^{th} second lines exclusively, so as to transmit the corresponding second data signals to the corresponding pixels, where i is an integer greater than or equal to 0.

According to an embodiment of the invention, the display panel further includes a data driver that is disposed on the substrate and located on a third side of the display area. The data driver is electrically connected to the first lines and the second lines to provide the first data signals and the second data signals, and the third side of the display area is different from the first side and the second side of the display area.

In an embodiment of the invention, a display apparatus that includes the aforesaid display panel and a timing controller is provided. The timing controller is electrically connected to the data driver to control the data driver to provide the first data signals and the second data signals.

According to an embodiment of the invention, the first data signals respectively received by each of the first lines and the adjacent first lines have different polarities, and the second data signals respectively received by each of the second lines and the adjacent second lines have different polarities.

According to an embodiment of the invention, the polarity of the first data signal received by the (4i+1)^{th} data line is the same as the polarity of the second data signal received by the (4i+3)^{th} data line.

According to an embodiment of the invention, each of the first data signals alternately corresponds to two of red display data, green display data, and blue display data, and each of the second data signals alternately corresponds to two of the red display data, the green display data, and the blue display data.

According to an embodiment of the invention, the pixels include a plurality of red pixels, a plurality of green pixels, and a plurality of blue pixels. The red pixels are not adjacent to one another, the green pixels are not adjacent to one another, and the blue pixels are not adjacent to one another.

According to an embodiment of the invention, each of the red pixels adjoins the corresponding green pixels and the corresponding blue pixels, each of the green pixels adjoins the corresponding red pixels and the corresponding blue pixels, and each of the blue pixels adjoins the corresponding red pixels and the corresponding green pixels.

According to an embodiment of the invention, the display panel further includes a plurality of scan lines disposed on the substrate and electrically connected to the corresponding pixels. The scan lines receive a plurality of scan signals, so as to transmit the corresponding scan signals to the corresponding pixels.

According to an embodiment of the invention, the display apparatus further includes a scan driver electrically connected to the scan lines to provide the scan signals.

According to an embodiment of the invention, the data driver includes a plurality of first data channels, a plurality of second data channels, a plurality of third data channels, and a plurality of fourth data channels. The first data channels and the second data channels provide the first data signals, polarities of the first data signals provided by the first data channels are different from polarities of the first data signals provided by the second data channels, and the first data channels and the second data channels are alternately arranged along an extension direction of the data lines. The third data channels and the fourth data channels provide the second data signals, polarities of the second data signals provided by the third data channels are different from polarities of the second data signals provided by the fourth data channels, and the third data channels and the fourth data channels are alternately arranged along the extension direction of the data lines.

As described above, in the display apparatus and the display panel thereof, the arrangement of lines on the display panel allows the display panel to achieve display effects similar to those accomplished by applying a dot inversion technique. Thereby, human eyes are not apt to perceive the vertical stripes, and color errors are not prone to occur between blocks of the display panel. As a result, the display effects of the display panel may be improved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram illustrating a display apparatus according to an embodiment of the invention.

FIG. 2A and FIG. 2B are schematic diagrams illustrating display effects of a display panel according to an embodiment of the invention.

FIG. 3 is a schematic system diagram illustrating a data driver according to an embodiment of the invention.

FIG. 4 is a schematic system diagram illustrating a display apparatus according to another embodiment of the invention.

### DETAILED DESCRIPTION OF DISCLOSED EMBODIMENTS

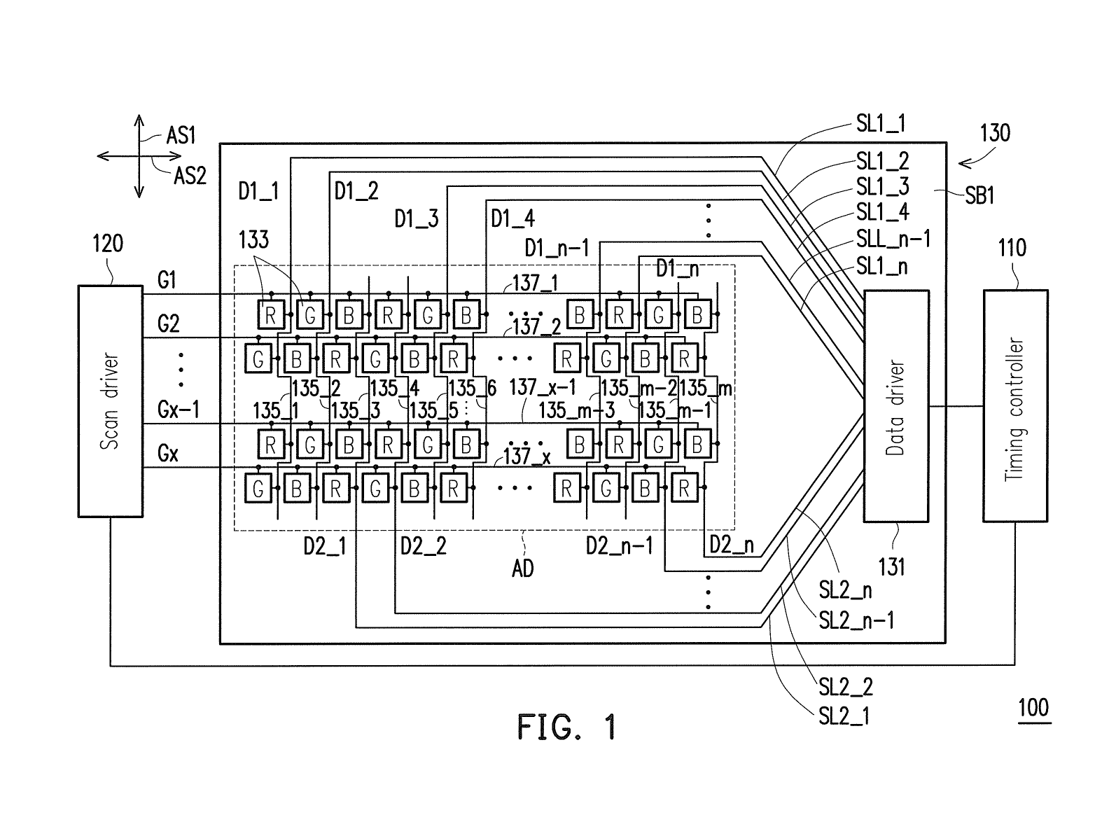

FIG. 1 is a schematic system diagram illustrating a display apparatus according to an embodiment of the invention. With reference to FIG. 1A, in this embodiment, the display apparatus 100 includes a timing controller 110, a scan driver 120, and a display panel 130. The scan driver 120 is electrically connected to the timing controller 110. Besides, the scan driver 120 is controlled by the timing controller 110 to provide a plurality of scan signals G1 to Gx to the display panel 130, wherein x is a positive integer.

The display panel 130 includes a substrate SB1, a data driver 131, a plurality of pixels 133, a plurality of first lines SL1_1 to SL1_{—}n, a plurality of second lines SL2_1˜SL2_{—}n, a plurality of data lines 135_1 to 135_{—}m, and a plurality of scan lines 137_1 to 137_{—}x, wherein m and n are positive integers, and m is twice as large as n, for instance. The pixels 133 are disposed on the substrate SB1 and located in a display area AD of the display panel 130, wherein areas other than the display area AD of the substrate SB1 may be considered as peripheral areas of the display panel 130.

The first lines SL1_1 to SL1_{—}n are disposed on the substrate SB1 and located on a first side of the display area AD. Besides, the first lines SL1_1 to SL1_{—}n receive a plurality of first data signals D1_1 to D1_{—}n provided by the data driver 131. The second lines SL2_1 to SL2_{—}n are disposed on the substrate SB1 and located on a second side of the display area AD. Besides, the second lines SL2_1 to SL2_{—}n receive a plurality of second data signals D2_1 to D2_{—}n provided by the data driver 131. In the present embodiment, the first side is, for instance, the top side, and the second side is, for instance, a bottom side opposite to the top side.

The data lines 135_1 to 135_{—}m are electrically connected to the corresponding pixels 133. For instance, the data line 135_1 is electrically connected to the first pixel 133 in each row, the data line 135_2 is electrically connected to the second pixel 133 in each row, and so forth. Besides, the first data line 135_1 is electrically connected to the first first line SL1_1, so as to sequentially transmit the first data signal D1_1 to the first pixel 133 in each row; the second data line 135_2 is electrically connected to the second first line SL1_2, so as to sequentially transmit the first data signal D1_2 to the second pixel 133 in each row. the third data line 135_3 is electrically connected to the first second line SL2_1, so as to sequentially transmit the second data signal D2_1 to the third pixel 133 in each row; the fourth data line 135_4 is electrically connected to the second second line SL2_2, so as to sequentially transmit the second data signal D2_2 to the fourth pixel 133 in each row; the fifth data line 135_5 is electrically connected to the third first line SL1_3, so as to sequentially transmit the first data signal D1_3 to the fifth pixel 133 in each row; the sixth data line 135_6 is electrically connected to the fourth first line SL1_4, so as to sequentially transmit the first data signal D1_4 to the sixth pixel 133 in each row. The rest may be deduced from the above. That is, two of the data lines 135_1 to 135_{—}m are considered as one group, and every two of the data lines 135_1 to 135_{—}m are alternately and electrically connected to the corresponding first lines (e.g., SL1_1 to SL1_{—}n) and the corresponding second lines (e.g., SL2_1 to SL2_{—}n).

The data driver 131 is disposed on the substrate SB1 and located on a third side of the display area AD, wherein the third side of the display area AD is different from the first side and the second side of the display area AD, and the third side herein refers to the right side, for instance. The data driver 131 is electrically connected to the first lines SL1_1 to SL1_{—}n, the second lines SL2_1 to SL2_{—}n, and the timing controller 110, and the data driver 131 is controlled by the timing controller 110 to provide the first data signals D1_1 to D1_{—}n and the second data signals D2_1 to D2_{—}n. The scan lines 137_1 to 137_{—}x are located on the substrate SB1 and electrically connected to the corresponding pixels 133, respectively. For instance, the scan line 137_1 is electrically connected to all the pixels 133 in the first row, the scan line 137_2 is electrically connected to all the pixels 133 in the second row, and so forth. Additionally, the scan lines 137_1 to 137_{—}x are electrically connected to the scan driver 120 to receive scan signals G1 to Gx, and the corresponding scan signals (e.g., G1 to Gx) are transmitted to the corresponding pixels 133. For instance, the scan line 137_1 receives and transmits the scan signal G1 to all the pixels 133 in the first row, the scan line 137_2 receives and transmits the scan signal G2 to all the pixels 133 in the second row, and so on. An extension direction AS2 of the scan lines 137_1 to 137_{—}x may be perpendicular to an extension direction AS1 of the data lines 135_1 to 135_{—}m, which should however not be construed as a limitation to the invention.

According to the present embodiment, the first data signals (e.g., D1_1 to D1_{—}n) respectively received by each of the first lines (e.g., SL1_1 to SL1_{—}n) and the adjacent first lines (e.g., SL1_1 to SL1_{—}n) have different polarities; namely, at the same time, the polarity of the first data signal D1_1 is different from that of the first data signal D1_2, and the polarity of the first data signal D1_2 is different from that of the first data signal D1_3. The second data signals (e.g., D2_1 to D2_{—}n) respectively received by each of the second lines (e.g., SL2_1 to SL2_{—}n) and the adjacent second lines (e.g., SL2_1 to SL2_{—}n) have different polarities; namely, at the same time, the polarity of the second data signal D2_1 is different from that of the second data signal D2_2, and the polarity of the second data signal D2_2 is different from that of the second data signal D2_3.

According to the present embodiment, the polarity of the first data signal D1_1 received by the first data line 135_1 is set to be equal to the polarity of the second data signal D2_1 received by the third data line 135_3, the polarity of the first data signal D1_2 received by the second data line 135_2 is set to be equal to the polarity of the second data signal D2_2 received by the fourth data line 135_4, and so on. That is, the polarity of the first data signal D1_1 received by the first first line SL1_1 is equal to the polarity of the second data signal D2_1 received by the first second line SL2_1, the polarity of the first data signal D1_2 received by the second first line SL1_2 is equal to the polarity of the second data signal D2_2 received by the second second line SL2_2, and so on.

The pixels 133 include a plurality of red pixels R, a plurality of green pixels G, and a plurality of blue pixels B, and the red pixels R, the green pixels G, and the blue pixels B are adjacent and arranged in a delta-like manner. That is, the arrangement of the pixels 133 is shaped as a delta in the present embodiment, for instance. Due to said arrangement of the pixels 133, each of the red pixels R adjoins the corresponding green pixels G and the corresponding blue pixels B, each of the green pixels G adjoins the corresponding red pixels R and the corresponding blue pixels B, and each of the blue pixels B adjoins the corresponding red pixels R and the corresponding green pixels G In other words, the red pixels R are not adjacent to one another, the green pixels G are not adjacent to one another, and the blue pixels B are not adjacent to one another.

According to the arrangement of the pixels 133, each of the first data signals (e.g., D1_1 to D1_{—}n) alternately corresponds to two of red display data, green display data, and blue display data. For instance, the first data signal D1_1 alternately corresponds to the red display data and the green display data, the first data signal D1_2 alternately corresponds to the green display data and the blue display data. The rest may be deduced from what is shown in FIG. 1. Similarly, each of the second data signals (e.g., D2_1 to D2_{—}n) alternately corresponds to two of red display data, green display data, and blue display data. For instance, the second data signal D2_1 alternately corresponds to the blue display data and the red display data, the second data signal D2_2 alternately corresponds to the red display data and the green display data. The rest may be deduced from what is shown in FIG. 1. The first data signal (e.g., D1_1 to D1_{—}n) or the second data signal (e.g., D2_1 to D2_{—}n) received by each data line (e.g., SL1_1˜SL1_{—}n) corresponds to the color display data different from the color display data corresponding to the first data signal (e.g., D1_1 to D1_{—}n) or the second data signal (e.g., D2_1 to D2_{—}n) received by the adjacent data line (e.g., SL1_1˜SL1_{—}n).

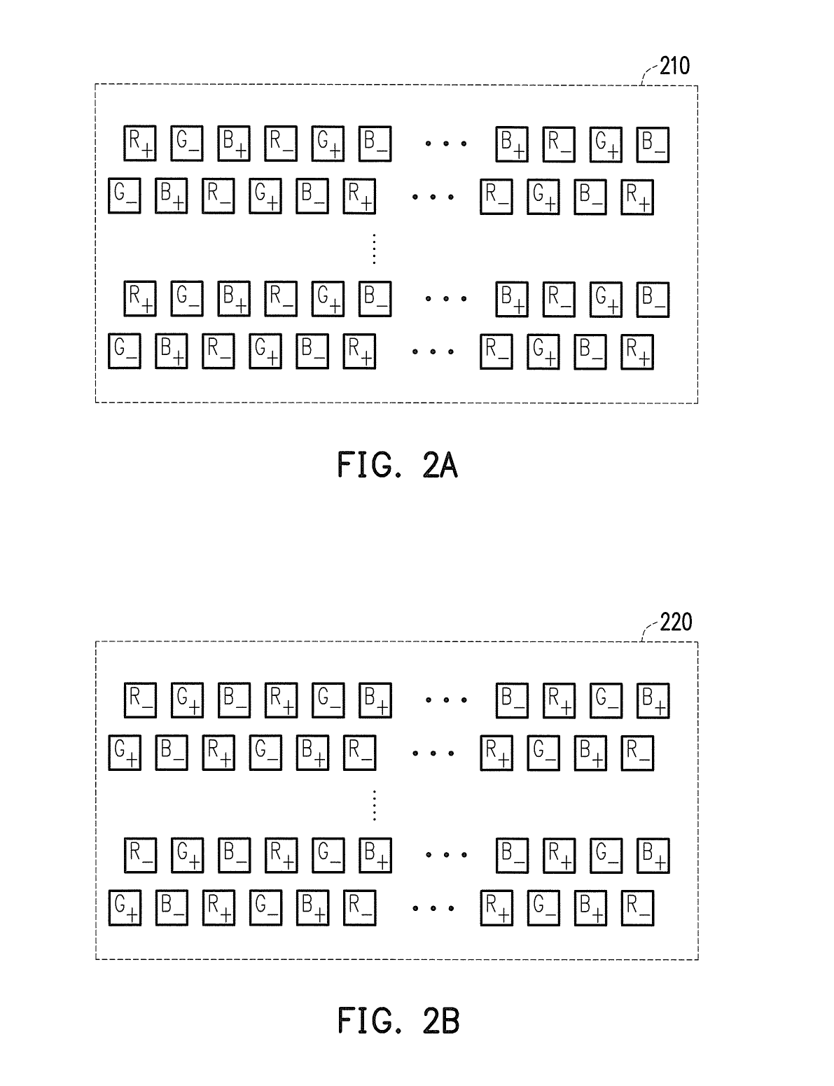

FIG. 2A and FIG. 2B are schematic diagrams illustrating display effects of a display panel according to an embodiment of the invention. With reference to FIG. 1, FIG. 2A, and FIG. 2B, in the present embodiment, the data driver 131 generates the first data signals D1_1 to D1_{—}n and the second data signals D2_1 to D2_{—}n in a dot inversion manner, for instance.

In one frame period, when the pixel 133 electrically connected to the scan line 137_1 is controlled by the scan signal G1 and is then turned on, the polarity of the first data signal D1_1 is positive (“+”), and the first data signal D1_1 corresponds to the red display data; the polarity of the first data signal D1_2 is negative (“−”), and the first data signal D1_2 corresponds to the green display data; the polarity of the second data signal D2_1 is positive (“+”), and the second data signal D2_1 corresponds to the blue display data; the polarity of the second data signal D2_2 is negative (“—”), and the second data signal D2_2 corresponds to the red display data. The rest may be deduced from what is shown in FIG. 1. When the pixel 133 electrically connected to the scan line 137_2 is controlled by the scan signal G2 and is then turned on, the polarity of the first data signal D1_1 is negative (“−”), and the first data signal D1_1 corresponds to the green display data; the polarity of the first data signal D1_2 is positive (“+”), and the first data signal D1_2 corresponds to the blue display data; the polarity of the second data signal D2_1 is negative (“−”), and the second data signal D2_1 corresponds to the red display data; the polarity of the second data signal D2_2 is positive (“+”), and the second data signal D2_2 corresponds to the green display data. The rest may be deduced from what is shown in FIG. 1. Besides, the way to electrically connect the pixels 133 to other scan lines 137_3 to 137_{—}x is similar to those described above and may also be deduced from what is depicted in FIG. 1, and therefore no further description is provided hereinafter. After all of the pixels 133 are driven in the aforesaid manner, the display effects 210 may be achieved, i.e., the polarities of the pixels 133 are distributed in a dot inversion manner.

In the next frame period, when the pixel 133 electrically connected to the scan line 137_1 is controlled by the scan signal G1 and is then turned on, the polarity of the first data signal D1_1 is negative (“−”), and the first data signal D1_1 corresponds to the red display data; the polarity of the first data signal D1_2 is positive (“+”), and the first data signal D1_2 corresponds to the green display data; the polarity of the second data signal D2_1 is negative (“−”), and the second data signal D2_1 corresponds to the blue display data; the polarity of the second data signal D2_2 is positive (“+”), and the second data signal D2_2 corresponds to the red display data. The rest may be deduced from what is shown in FIG. 1. When the pixel 133 electrically connected to the scan line 137_2 is controlled by the scan signal G2 and is then turned on, the polarity of the first data signal D1_1 is positive (“+”), and the first data signal D1_1 corresponds to the green display data; the polarity of the first data signal D1_2 is negative (“−”), and the first data signal D1_2 corresponds to the blue display data; the polarity of the second data signal D2_1 is positive (“+”), and the second data signal D2_1 corresponds to the red display data; the polarity of the second data signal D2_2 is negative (“−”), and the second data signal D2_2 corresponds to the green display data. The rest may be deduced from what is shown in FIG. 1. Besides, the way to electrically connect the pixels 133 to other scan lines 137_3 to 137_{—}x is similar to those described above and may also be deduced from what is depicted in FIG. 1, and therefore no further description is provided hereinafter. After all of the pixels 133 are driven in the aforesaid manner, the display effects 220 may be achieved, i.e., the polarities of the pixels 133 are also distributed in a dot inversion manner.

As discussed above, the display effects (e.g., 210 and 220) achieved by the display panel 130 as if the polarities of the pixels are distributed in the dot inversion manner. Thereby, given that the positive-negative voltage difference of the DC common voltage (not shown) applied to the display panel 130 is excessive, the distance between dark and bright stripes on the frame is rather small, and the sensitivity of human eyes to the stripes on the display frames may be equalized. As such, the human eyes are not apt to perceive the vertical stripes. Moreover, said driving manner may help correct the color errors occurring between blocks of the display panel.

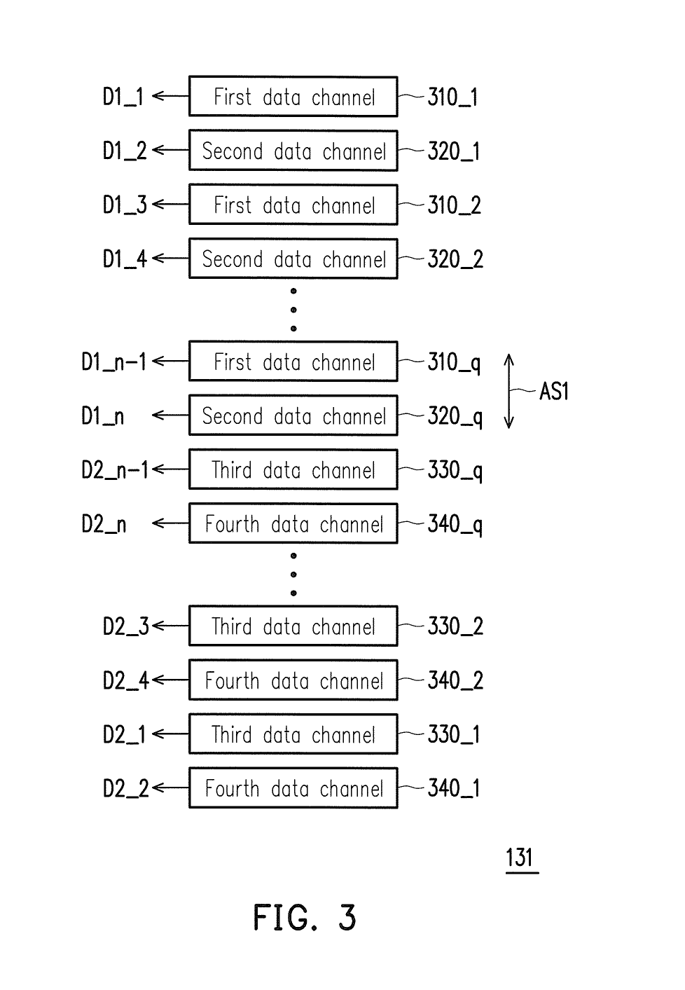

FIG. 3 is a schematic system diagram illustrating a data driver according to an embodiment of the invention. With reference to FIG. 1 and FIG. 3, according to the present embodiment, the data driver 131 includes a plurality of first data channels 310_1 to 310_{—}q, a plurality of second data channels 320_1 to 320_{—}q, a plurality of third data channels 330_1 to 330_{—}q, and a plurality of fourth data channels 340_1 to 340_{—}q, wherein q is a positive integer and is ½ of n, for instance. The first data channels 310_1 to 310_{—}q and the second data channels 320_1 to 320_{—}q are alternately arranged along the extension direction AS1 of the data lines 135_1 to 135_{—}m, and the third data channels 330_1 to 330_{—}q and the fourth data channels 340_1 to 340_{—}q are alternately arranged along the extension direction AS1 of the data lines 135_1 to 135_{—}m. In the present embodiment, the first data channels 310_1 to 310_{—}q and the second data channels 320_1 to 320_{—}q are not alternately arranged with the third data channels 330_1 to 330_{—}q and the fourth data channels 340_1 to 340_{—}q, which should however not be construed as a limitation to the invention.

The first data channels 310_1 to 310_{—}q and the second data channels 320_1 to 320_{—}q provide the first data signals D1_1 to D1_{—}n. For instance, the first data channel 310_1 provides the first data signal D1_1, the second data channel 320_1 provides the first data signal D1_2, the first data channel 310_2 provides the first data signal D1_3, the second data channel 320_2 provides the first data signal D1_4, and so forth. Besides, the polarities of the first data signals (e.g., D1_1, D1_3, etc.) provided by the first data channels 310_1 to 310_{—}q are different from polarities of the first data signals (e.g., D1_2, D1_4, etc.) provided by the second data channels 320_1 to 320_{—}q. That is, if the polarities of the first data signals (e.g., D1_1, D1_3, etc.) provided by the first data channels 310_1 to 310_{—}q are positive (“+”), the polarities of the first data signals (e.g., D1_2, D1_4, etc.) provided by the second data channels 320_1 to 320_{—}q are negative (“−”); if the polarities of the first data signals (e.g., D1_1, D1_3, etc.) provided by the first data channels 310_1 to 310_{—}q are negative (“−”), the polarities of the first data signals (e.g., D1_2, D1_4, etc.) provided by the second data channels 320_1 to 320_{—}q are positive (“+”).

The third data channels 330_1 to 330_{—}q and the fourth data channels 340_1 to 340_{—}q provide the second data signals D2_1 to D2_{—}n. For instance, the third data channel 330_1 provides the second data signal D2_1, the fourth data channel 340_1 provides the second data signal D2_2, the third data channel 330_2 provides the second data signal D2_3, the fourth data channel 340_2 provides the second data signal D2_4, and so forth. Besides, the polarities of the second data signals (e.g., D2_1, D2_3, etc.) provided by the third data channels 330_1 to 330_{—}q are different from polarities of the second data signals (e.g., D2_2, D2_4, etc.) provided by the fourth data channels 340_1 to 340_{—}q. That is, if the polarities of the second data signals (e.g., D2_1, D2_3, etc.) provided by the third data channels 330_1 to 330_{—}q are positive (“+”), the polarities of the second data signals (e.g., D2_2, D2_4, etc.) provided by the fourth data channels 340_1 to 340_{—}q are negative (“−”); if the polarities of the second data signals (e.g., D2_1, D2_3, etc.) provided by the third data channels 330_1 to 330_{—}q are negative (“−”), the polarities of the second data signals (e.g., D2_2, D2_4, etc.) provided by the fourth data channels 340_1 to 340_{—}q are positive (“+”).

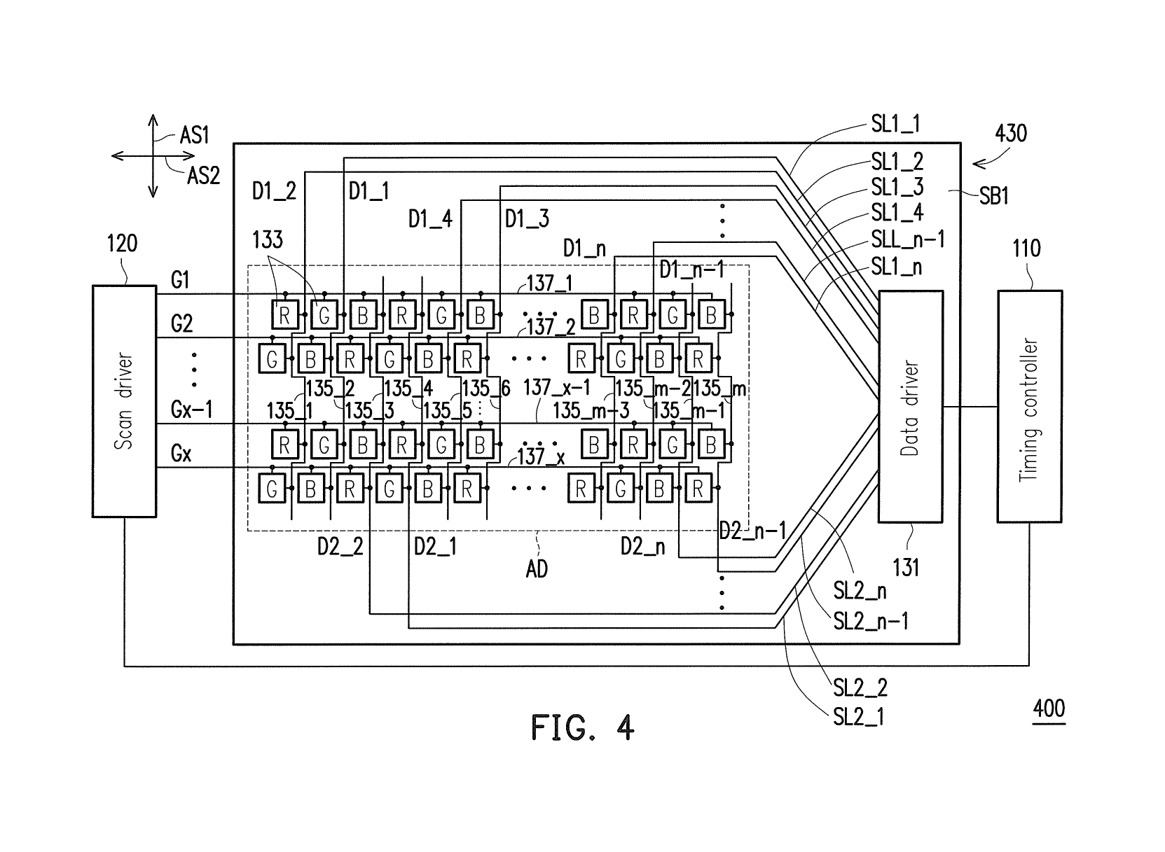

FIG. 4 is a schematic system diagram illustrating a display apparatus according to another embodiment of the invention. With reference to FIG. 1 and FIG. 4, the display apparatus 400 is similar to the display apparatus 100, while the difference therebetween lies in the electrical connection between the data lines 135_1 to 135_{—}m and the first and second lines SL1 _1 to SL1_{—}n and SL2_1 to SL2_{—}n in the display panel 430. The same or similar components in FIG. 1 and FIG. 4 are marked by the same or similar reference numbers. The data line 135_1 is electrically connected to the first line SL1_2, so as to sequentially transmit the first data signal D1_2 to the first pixel 133 in each row; the data line 135_2 is electrically connected to the first line SL1_1, so as to sequentially transmit the first data signal D1_1 to the second pixel 133 in each row; the data line 135_3 is electrically connected to the second line SL2_2, so as to sequentially transmit the second data signal D2_2 to the third pixel 133 in each row; the data line 135_4 is electrically connected to the second line SL2_1, so as to sequentially transmit the second data signal D2_1 to the fourth pixel 133 in each row; the data line 135_5 is electrically connected to the first line SL1_4, so as to sequentially transmit the first data signal D1_4 to the fifth pixel 133 in each row; the data line 135_6 is electrically connected to the first line SL1_3, so as to sequentially transmit the first data signal D1_3 to the sixth pixel 133 in each row; the rest may be deduced from the above.

According to the arrangement of the pixels 133, the first data signal D1_1 alternately corresponds to the green and blue display data, the first data signal D1_2 alternately corresponds to the red and green display data, and the rest may be deduced from what is shown in FIG. 1. Likewise, the second data signal D2_1 alternately corresponds to the red and green display data, the second data signal D2_2 alternately corresponds to the blue and red display data, and the rest may be deduced from what is shown in FIG. 1. Besides, according to the driving manner described in the embodiment shown in FIG. 2A and FIG. 2B, the display effects accomplished by the display panel 430 are substantially the same as the display effects 210 and 220.

According to the embodiment shown in FIG. 1, each of the (4i+1)^{th} and) (4i+2)^{th} data lines (e.g., 135_1 and 135_2) is electrically connected to one of the (2i+1)^{th} and (2i+2)^{th} first lines (e.g., SL1_1 and SL1_2) exclusively, so as to transmit the corresponding first data signals (e.g., D1_1 and D1_2) to the corresponding pixels 133; each of the (4i+3)^{th} and (4i+4)^{th} data lines (e.g., 135_3 and 135_4) is electrically connected to one of the (2i+1)^{th} and (2i+2)^{th} second lines (e.g., SL2_1 and SL2_2) exclusively, so as to transmit the corresponding second data signals (e.g., D2_1 and D2_2) to the corresponding pixels 133, where i is an integer greater than or equal to 0.

According to the embodiment shown in FIG. 4, each of the (4i+1)^{th} and (4i+2)^{th} data lines (e.g., 135_1 and 135_2) is electrically connected to one of the (2i+1)^{th} and (2i+2)^{th} first lines (e.g., SL1 _1 and SL1 _1) exclusively, so as to transmit the corresponding first data signals (e.g., D1_2 and D1_1) to the corresponding pixels 133; each of the (4i+3)^{th} and (4i+4)^{th} data lines (e.g., 135_3 and 135_4) is electrically connected to one of the (2i+1)^{th} and (2i+2)^{th} second lines (e.g., SL2_2 and SL2_1) exclusively, so as to transmit the corresponding second data signals (e.g., D2_2 and D2_1) to the corresponding pixels 133, where i is an integer greater than or equal to 0.

In another aspect, according to an embodiment of the invention, the scan driver 120 and the data driver 131 may be integrated into one driving chip and located on the substrate SB1, which should however not be construed as a limitation to the invention.

To sum up, in the display apparatus and the display panel thereof described herein, the arrangement of lines on the display panel and the way to generate data signals by means of the data driver allow the display panel to achieve display effects similar to those accomplished by applying a dot inversion technique. Thereby, human eyes are not apt to perceive the vertical stripes, and color errors are not prone to occur between blocks of the display panel. As a result, the display effects of the display panel may be improved.

Although the invention has been described with reference to the above embodiments, it will be apparent to one having the ordinary skill in the art that modifications to the described embodiment may be made without departing from the spirit of the invention. Accordingly, the scope of the invention will be defined by the attached claims not by the above detailed descriptions.

What is claimed is:

1. A display panel comprising:
a substrate;
a plurality of pixels disposed on the substrate and located at a display area of the display panel;
a plurality of first lines disposed on the substrate and located on a first side of the display area, the first lines receiving a plurality of first data signals;
a plurality of second lines disposed on the substrate and located on a second side of the display area, the second lines receiving a plurality of second data signals, wherein the second side of the display area is opposite to the first side of the display area; and
a plurality of data lines electrically connected to corresponding pixels of the pixels, wherein each of a (4i+1)^{th} data line and a (4i+2)^{th} data line of the data lines is electrically connected to one of a (2i+1)^{th} first line and a (2i+2)^{th} first line of the first lines exclusively, so as to transmit corresponding first data signals of the first data signals to the corresponding pixels, each of a (4i+3)^{th} data line and a (4i+4)^{th} data line of the data lines is electrically connected to one of a (2i+1)^{th} second line and a (2i+2)^{th} second line of the second lines exclusively, so as to transmit corresponding second data signals of the second data signals to the corresponding pixels, and i is an integer greater than or equal to 0.

2. The display panel as recited in claim 1, wherein the first data signals respectively received by each of the first lines and the adjacent first lines have different polarities, and the second data signals respectively received by each of the second lines and the adjacent second lines have different polarities.

3. The display panel as recited in claim 2, wherein the polarity of the first data signal received by the (4i+1)^{th} data line is the same as the polarity of the second data signal received by the (4i+3)^{th} data line.

4. The display panel as recited in claim 1, wherein each of the first data signals alternately corresponds to two of red display data, green display data, and blue display data, and each of the second data signals alternately corresponds to two of the red display data, the green display data, and the blue display data.

5. The display panel as recited in claim 1, wherein the pixels comprise a plurality of red pixels, a plurality of green pixels, and a plurality of blue pixels, the red pixels are not adjacent to one another, the green pixels are not adjacent to one another, and the blue pixels are not adjacent to one another.

6. The display panel as recited in claim 5, wherein each of the red pixels adjoins corresponding green pixels of the green pixels and corresponding blue pixels of the blue pixels, each of the green pixels adjoins corresponding red pixels of the red pixels and corresponding blue pixels of the blue pixels, and each of the blue pixels adjoins corresponding red pixels of the red pixels and corresponding green pixels of the green pixels.

7. The display panel as recited in claim 1, further comprising:
a plurality of scan lines disposed on the substrate and electrically connected to corresponding pixels of the pixels, the scan lines receiving a plurality of scan signals, so as to transmit corresponding scan signals of the scan signals to the corresponding pixels.

8. The display panel as recited in claim 1, further comprising:
a data driver disposed on the substrate and located on a third side of the display area, the data driver being electrically connected to the first lines and the second lines to provide the first data signals and the second data signals, wherein the third side of the display area is different from the first side and the second side of the display area.

9. The display panel as recited in claim 8, wherein the data driver comprises a plurality of first data channels, a plurality of second data channels, a plurality of third data channels, and a plurality of fourth data channels,
the first data channels and the second data channels provide the first data signals, polarities of the first data signals provided by the first data channels are different from polarities of the first data signals provided by the second data channels, the first data channels and the second data channels are alternately arranged along an extension direction of the data lines,
the third data channels and the fourth data channels provide the second data signals, polarities of the second data signals provided by the third data channels are different from polarities of the second data signals provided by the fourth data channels, and the third data channels and the fourth data channels are alternately arranged along the extension direction of the data lines.

10. A display apparatus comprising:
a display panel comprising:
a substrate;
a plurality of pixels disposed on the substrate and located at a display area of the display panel;
a plurality of first lines disposed on the substrate and located on a first side of the display area, the first lines receiving a plurality of first data signals;
a plurality of second lines disposed on the substrate and located on a second side of the display area, the second lines receiving a plurality of second data signals, wherein the second side of the display area is opposite to the first side of the display area;
a plurality of data lines electrically connected to corresponding pixels of the pixels, wherein each of a (4i+1)^{th} data line and a (4i+2)^{th} data line of the data lines is electrically connected to one of a (2i+1)^{th} first line and a (2i+2)^{th} first line of the first lines exclusively, so as to transmit corresponding first data signals of the first data signals to the corresponding pixels, each of a (4i+3)^{th} data line and a (4i+4)^{th} data line of) the data lines is electrically connected to one of a (2i+1)^{th} second line and a (2i+2)^{th} second line of the second lines exclusively, so as to transmit corresponding second data signals of the second data signals to the corresponding pixels, and i is an integer greater than or equal to 0; and
a data driver disposed on the substrate and located on a third side of the display area, the data driver being electrically connected to the first lines and the second lines to provide the first data signals and the second data signals, wherein the third side of the display area is different from the first side and the second side of the display area; and
a timing controller electrically connected to the data driver to control the data driver to provide the first data signals and the second data signals.

11. The display apparatus as recited in claim 10, wherein the first data signals respectively received by each of the first lines and the adjacent first lines have different polarities, and the second data signals respectively received by each of the second lines and the adjacent second lines have different polarities.

12. The display apparatus as recited in claim 11, wherein the polarity of the first data signal received by the (4i+1)^{th} data line is the same as the polarity of the second data signal received by the (4i+3)^{th} data line.

13. The display apparatus as recited in claim 10, wherein each of the first data signals alternately corresponds to two of red display data, green display data, and blue display data, and each of the second data signals alternately corresponds to two of the red display data, the green display data, and the blue display data.

14. The display apparatus as recited in claim 10, wherein the pixels comprise a plurality of red pixels, a plurality of green pixels, and a plurality of blue pixels, the red pixels are not adjacent to one another, the green pixels are not adjacent to one another, and the blue pixels are not adjacent to one another.

15. The display apparatus as recited in claim 14, wherein each of the red pixels adjoins corresponding green pixels of the green pixels and corresponding blue pixels of the blue pixels, each of the green pixels adjoins corresponding red pixels of the red pixels and corresponding blue pixels of the blue pixels, and each of the blue pixels adjoins corresponding red pixels of the red pixels and corresponding green pixels of the green pixels.

16. The display apparatus as recited in claim 10, wherein the display panel further comprises:
a plurality of scan lines disposed on the substrate and electrically connected to corresponding pixels of the pixels, the scan lines receiving a plurality of scan signals, so as to transmit corresponding scan signals of the scan signals to the corresponding pixels.

17. The display apparatus as recited in claim 16, further comprising:
a scan driver electrically connected to the scan lines to provide the scan signals.

18. The display apparatus as recited in claim 10, wherein the data driver comprises a plurality of first data channels, a plurality of second data channels, a plurality of third data channels, and a plurality of fourth data channels,
the first data channels and the second data channels provide the first data signals, polarities of the first data signals provided by the first data channels are different from polarities of the first data signals provided by the second data channels, the first data channels and the second data channels are alternately arranged along an extension direction of the data lines,
the third data channels and the fourth data channels provide the second data signals, polarities of the second data signals provided by the third data channels are different from polarities of the second data signals provided by the fourth data channels, and the third data channels and the fourth data channels are alternately arranged along the extension direction of the data lines.
